(19) United States
(12) Patent Application Publication
(10) Pub. No.: US 2011/0293793 A1
(43) Pub. Date: Dec. 1, 2011

(54) SYSTEMS AND METHODS FOR WINE TASTING AND THE MARKETING OF WINE, AND WINE PACKAGING USEFUL THEREWITH

(76) Inventor: Lawrence Edward Strodtman, Indianapolis, IN (US)

(21) Appl. No.: 13/118,949

(22) Filed: May 31, 2011

Related U.S. Application Data
(63) Continuation of application No. 11/444,007, filed on May 31, 2006, now abandoned.

(51) Int. Cl. C12G 1/00; B65D 85/72

(52) U.S. Cl. 426/87

(57) ABSTRACT

New and unique systems and methods for distributing and marketing of wine are disclosed, and associated wine packaging. In one embodiment, several single-serving containers of differing wines are provided to a customer in a single package. Each individual container is associated with a reference code, but otherwise has no visible indicia to identify the particular wine contained therein. A data sheet, provided with the package or separately provided such as at an on-line website, identifies each wine by its reference code and provides particulars about the wine and for the placing of quantity orders, as desired. The customer would thus be able to objectively taste and compare a variety of wines in a convenient manner, identify each individual sample by its unique reference code after tasting, and further conveniently order wines of identified preference.

### CROSS-REFERENCE TO RELATED APPLICATION

The present application is a continuation application to U.S. patent application Ser. No. 11/444,007 filed May 31, 2006, which is hereby incorporated by reference in its entirety.

### FIELD OF THE DISCLOSURE

The present disclosure broadly concerns the distribution and marketing of wine. More particularly, the present disclosure relates to systems and methods for facilitating the blind tasting of wine and the subsequent completion of wine sales, and related wine packaging.

### BACKGROUND

The American wine industry has grown from its humble beginnings in colonial America, through the era of prohibition, and into its current level of sophistication. As with many industries, the wine industry includes both large and small participants. Typically, the representative large winery produces massive quantities of wine for distribution to retail outlets and liquor stores around the world, while smaller wineries struggle to reach these distribution channels.

The number of small wineries in the United States is growing rapidly. In 2005 there were 4,000 small wineries, each typically producing less than 5,000 cases a year. However, in contrast, the number of wine distributors has decreased through a series of mergers. Small wineries complain that the national distributors are too expensive to work with and ignore small companies in favor of a few big brands. As a result, 80 percent of wine sales come from just 100 brands such as E&J Gallo Winery, Robert Mondavi Corp. and Beringer Blass Wine Estates Ltd.

As a result of the above distribution network, small wineries of America fit into a much smaller niche in the market, and must resort to alternative sales methods. For example, the smaller wineries of Napa Valley in California produce wines, but often also provide an experience to wine connoisseurs and tourists alike who frequently visit their region. This helps to promote the sales of their wines either directly from the winery, their tasting room, or through a local distributor.

Blind sampling of wine is a common practice amongst wine enthusiasts, connoisseurs, and social groups. Typically, one or more people, serving as the host, would coordinate the event and purchase a variety of wines and either disguise the bottles or place the wines in a decanter or other container so as to hide their identity. Then, each person at the gathering would be able to sample one or more of the wines without knowledge as to the identity of each wine, or its origin, cost, or reputation. This allows the taster to taste new wines absent any preconceived prejudices or influences, and expand their knowledge and appreciation of wines, while also potentially discovering a new wine they enjoy. For some, this is an intriguing way to refine an already discerning palette, while for others it is a social event which may often lead to the identification of new wines they enjoy. A fair amount of preparation is required, however, in selecting and obtaining the wines to be sampled and in concealing their identity to prepare for the event. And the ones setting up the blind tasting are often unable to fully participate and enjoy the event due to the fact that they are already aware of the identity of the wines being tasted.

### SUMMARY

The present invention generally provides new approaches and concepts for facilitating the blind tasting of wine and the subsequent completion of wine sales, and related wine packaging useful therewith.

This summary is not intended to identify key features or essential features of the claimed subject matter, nor is it intended to be used as an aid in determining the scope of the claimed subject matter. Reference is made to the appended claims.

### BRIEF DESCRIPTION OF THE DRAWINGS

FIG. 1 is a perspective view of a multiple-container package of one embodiment, having four containers.

FIG. 2a is a perspective view of a representative container from the multiple-container package of FIG. 1.

FIG. 2b is an alternate perspective view of the container of FIG. 2a.

FIG. 3 is an elevational view of a reference source in accordance with one embodiment of the present invention.

FIG. 4 is an elevational view of a web page suitable for use as a reference source in accordance with another embodiment.

FIG. 5 is a perspective view of a representative container according to another embodiment.

FIG. 6 is a perspective view of a representative container according to yet another embodiment.

FIG. 7 is a diagrammatic view of computer system 120 suitable for use in one embodiment of the present invention.

FIG. 8 is a flowchart showing one aspect of an associated method for distributing wine, suitable for use in the system of FIG. 7.

### DESCRIPTION OF THE ILLUSTRATIVE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is thereby intended, such alterations and further modifications in the illustrated devices, and such further applications of the principles of the disclosure as illustrated therein, being contemplated as would normally occur to one skilled in the art to which the disclosure relates.

Illustrative embodiments of the systems and methods of the present invention for facilitating the blind tasting of wine and the subsequent completion of wine sales will now be described. In one such embodiment, a system and method is provided by which individual wine containers, each particularly identifiable only by a reference code, are packaged together in a single multi-container package. The packages may then be distributed to consumers, for example, through retail stores or delivered as a result of the consumer placing an order, such as over the internet or via telephone. The consumer is then able to blindly sample the wines in the containers and thereafter learn the identity of each wine by correlating its associated reference code with a reference source. In one form, the reference source is provided by a website. In other forms, the reference source may be included with the package, or separately provided in another fashion, such as by mail, email, through handout materials, or telephonically. With the provided identification, the user is presented with an opportunity to place an order for the sampled wines. Retailers carrying the sampled wines or other sources for obtaining the sampled wines, such as links to internet sites where the wines may be directly ordered, may also be identified.

By one illustrative embodiment, a package is provided containing several containers of differing wines without readily identifiable marks. The package may also include a reference card or a link to a website for correlating the reference code on each container in order to identify the wine it contains after tasting. Additionally, the wines are selected from a wide variety of wineries, types, regions, and vintages and aren't limited to those wines available regionally. Therefore, an individual would be able to blindly sample wine on their own, or host a party with the blind tasting of wine from all over the country, from wineries both big and small, and easily place an order for any of the wines they received.

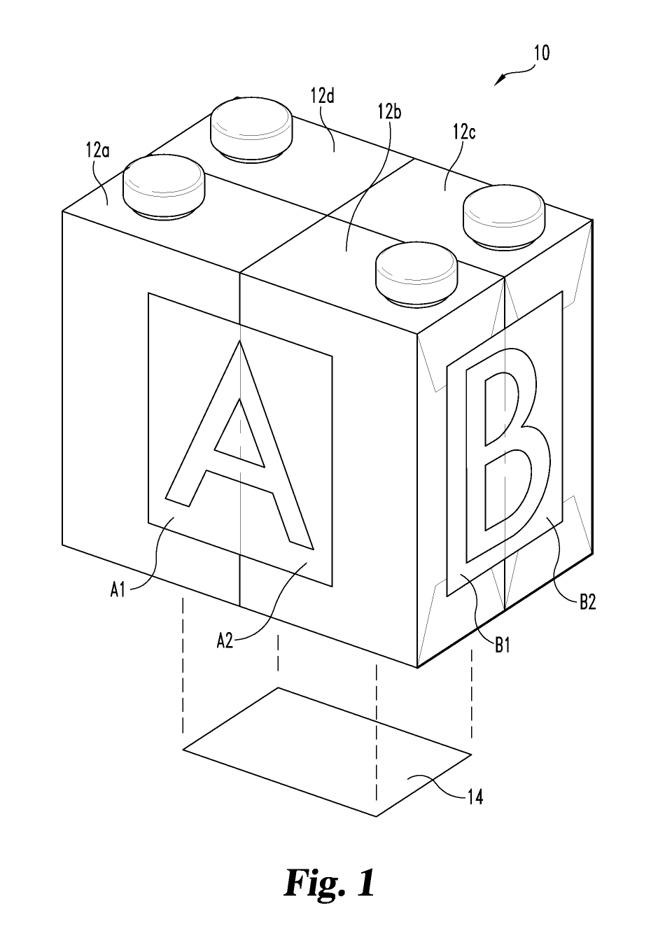

Referring to FIG. 1, a representative embodiment takes the form of a package 10 which comprises a plurality of containers, such as 12a, 12b, 12c, and 12d (collectively containers 12). It shall be understood that package 10 may include more or fewer containers 12, such as, by way of non-limiting example, 3, 4, or 6 containers. In order to facilitate efficient distribution and handling, containers 12 are preferably bound together. Containers 12 may be bound together using a variety of techniques known to one of skill in the art including, but not limited to, shrink wrapping, adhesion, and strapping. In an alternate embodiment, containers 12 may be re-packaged within a cardboard container or the like, which may also provide some form of temperature regulation and/or insulation to protect the contents of the containers from spoliation during shipping and/or storage.

In one preferred embodiment, each container 12 within package 10 contains a unique wine. In a further preferred embodiment, each container 12 contains a wine sharing a particular variety, vintage, region of growth, price range, or maker with the other containers in package 10. In an alternate embodiment, at least two containers 12 within package 10 contain wines having a different variety. Additionally, in one embodiment, package 10 includes reference source 14. Reference source 14 may be bound to the package 10, incorporated with the package 10, or otherwise included. In one preferred embodiment, reference source 14 is a reference card or printed pamphlet including information about the identity of the wines included in package 10. In a further preferred embodiment, the reference card 14 is included in a manner sufficient to hide its contents, such as enclosed within an envelope if printed, in order to prevent the consumer from learning the identity of the wines prior to tasting.

In the illustrated embodiment, package 10 has the image A on one face with a portion A1 of the image A on container 12a and another portion A2 of the image A on container 12b. More specifically, when the packages are bound together, using a method such as shrink-wrap, which does not cover the images on the containers 12, the image A is visible to the consumer as a combination of portions A1 and A2. Image A may comprise a company logo or trade name, promotional information, a product description, wine information, legally required warnings, or any other printed material. Package 10 may also include an image B comprised of portions B1 and B2, on an adjacent face, such as that defined by containers 12b and 12c.

It shall be appreciated that package 10 may have any number of faces and may include any number of distinct images upon those faces. However, in one preferred embodiment, for efficiency, package 10 includes two separate and distinct images on parallel faces. Thus, the front and back face may display the same image, while the two side faces may display another unique image. This allows for containers 12a and 12c and containers 12b and 12d to be identical, thus reducing packaging costs and the amount of inventory required during production. In an alternate embodiment, this effect may be accomplished by wrapping the containers 12 with a pre-printed material which displays the images and information desired.

Additionally, in the illustrative embodiment, the internal faces of containers 12, defined as those faces which abut a face of another container in package 10, may contain information specific to a container. For example, internal faces may include supplemental information, legal warnings, or an associated reference code either printed on the container or on an affixed label for identifying the wine contained.

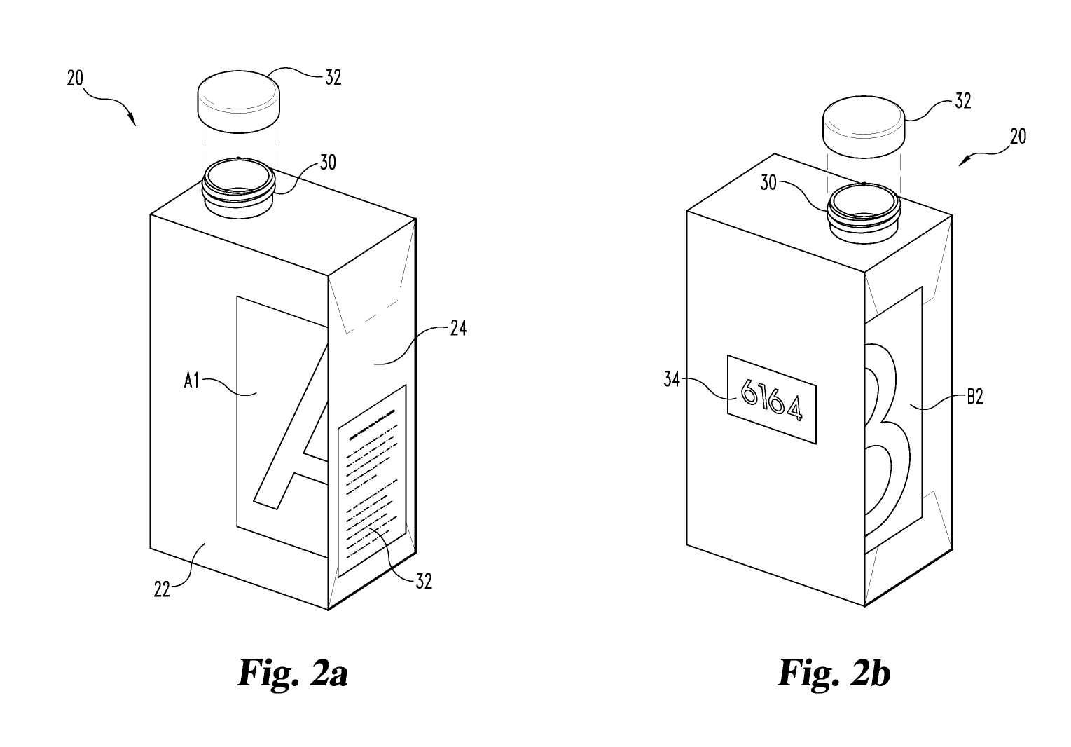

Turning to FIGS. 2a and 2b, in the illustrative embodiment containers 12 are in the form of a carton 20. Containers 12 may also be any suitable packaging for storing liquid including, but not limited to, a bottle, a can, a pouch, or any other liquid storage device known to one of skill in the art. In the illustrated embodiment, carton 20 is a sealed enclosure manufactured from a metallic composition suitable for preserving the wine contained therein. In this preferred embodiment, carton 20 is suitable for holding a single-serving of wine, such as 187 ml or 250 ml for providing a sampling for a small number of consumers such as one or two. In alternate embodiments, container 20 may hold 387 ml, 500 ml, 750 ml, 1000 ml, 1500 ml, or any other quantity of wine. Larger quantities of wine within a package 10, such as 1000 ml and 1500 ml, may be desirable in order to facilitate the hosting of a blind wine tasting party having a larger number of guests. A suitable product for use as carton 20 is the Tetra Prism Aseptic manufactured by Tetra Pak USA headquartered in Vernon Hills, Ill.

As illustrated, carton 20 comprises a front face 22, side face 24, back face 26, side face 28, and spout 30. In one embodiment, as discussed above, cartons 20 may be arranged within package 10 so that the outward faces of package 10 provide an image. To enable this, front face 22 of package 10 may present a portion of the image A as denoted by A1. Side face 24 and back face 26 which are internal faces, may contain supplemental information such as a warning 32 or a reference code 34 as illustrated. Side face 26 of carton 20 may then present a portion of the image B as denoted by B2. It shall be understood that in a four container per package arrangement, two distinct images could be placed on the sides of package 10 by utilizing two distinct containers 12 each having one portion of each image. Carton 20 also includes spout 30, such as the opening illustrated. Spout 30 may be in the form of a pull tab, puncturable seal, or any other beverage opening known to one of skill in the art. In one preferred embodiment, spout 30 is an annular opening having a threaded housing on the top of carton 20 and may include a threaded cap (as shown) for easy opening and resealing. It shall be understood that spout 30 may also be on the side of carton 20 in other embodiments.

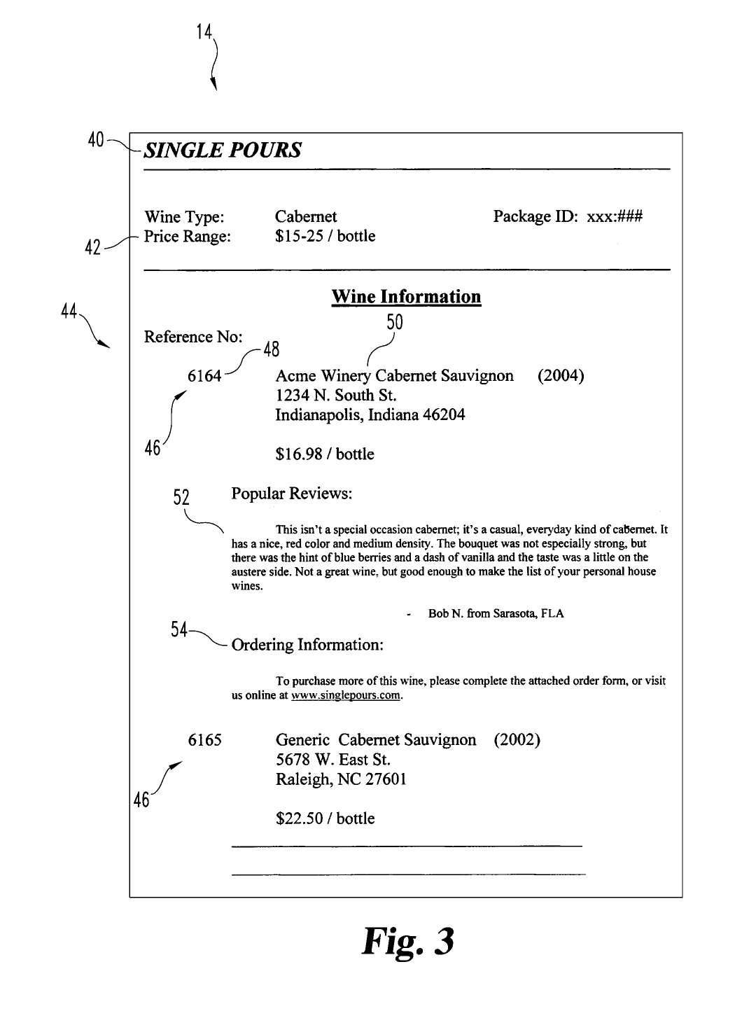

FIG. 3 illustrates one example of a representative reference source in one embodiment of the present system and method. Reference source 14 is shown as a pamphlet 40 which includes a header 42 containing information specific to the company which provides package 10, such as a company name, website, phone number, and logo. Additionally, pamphlet 40 is shown to include a package information section 42 which may include information relevant to the accompanying package 10 and its contents. For example, the type of wines contained may be provided as well as the particular price range in which all of the wines in the package fall. Additionally, a package ID indicating the particular compilation of wines included may be provided to allow consumers to specifically identify a package with the provider or in the event they would like to try a different package the next time or recommend a certain package to a friend.

A wine information section 44 includes a listing, such as listing 46, for each wine contained in the package. Listing 46 includes reference code 48 which corresponds to the reference code on an associated container in package 10. It shall be appreciated that reference code 48 may take on many forms as discussed herein. Listing 46 also includes the identity of the wine 50 and may also include the name of the winery, the wine's year of vintage, region of growth, and other information such as the address of the winery. Listing 46 may also include a selection of popular reviews 52 of the associated wine so that a consumer may see what others, including wine experts, think of the wine and compare their thoughts. Ordering information 54 is additionally included to provide the consumer with a convenient way of acquiring the identified wines. This ordering information may be a website, a phone number, a mail order form, or other various form for facilitating the taking of an order from the consumer.

It shall be understood that reference source 14 may be a pamphlet printed on paper or cardstock as illustrated, may be text or multimedia content published on a website, included on a compact disc or other storage media, or provided telephonically to name just a few representative examples. It shall be further understood that reference source 14 may be provided in any method sufficient to convey the identity of a wine given its associated reference code.

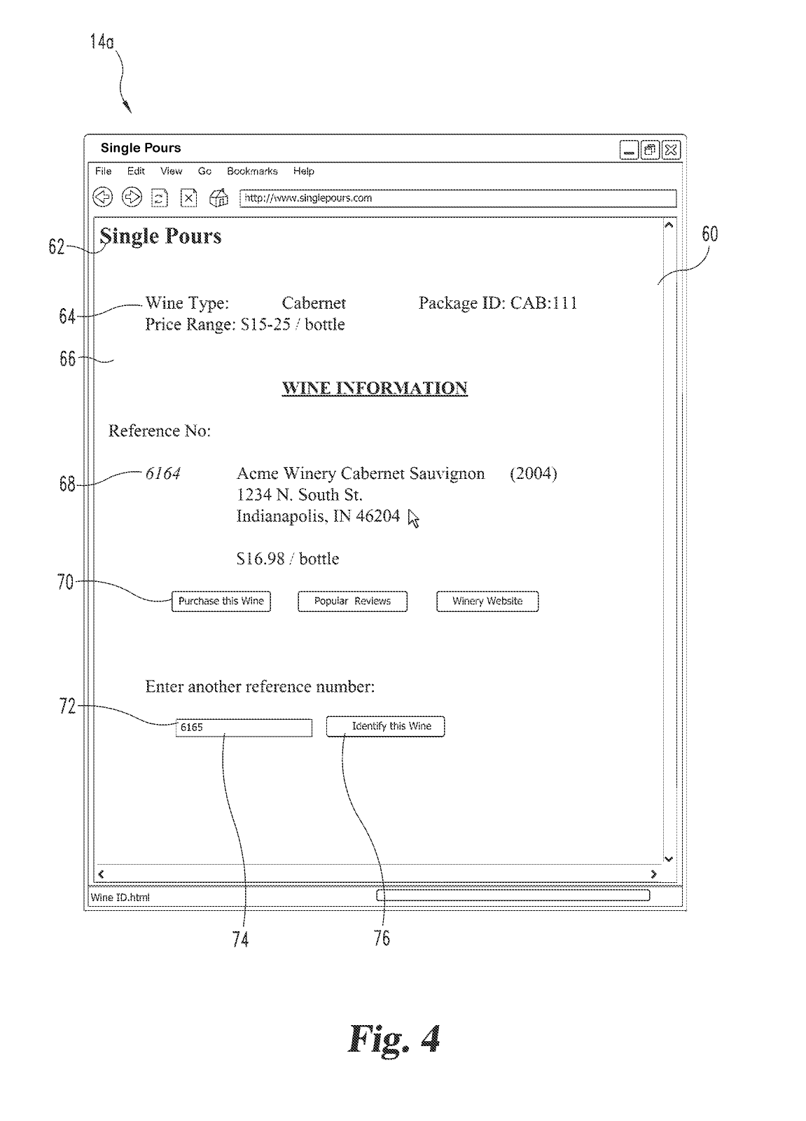

Turning to FIG. 4, wherein website 14a is illustrated serving as a reference source for use in one preferred embodiment. Website 14a may operate in a user's web browser, such as Microsoft Internet Explorer, Netscape, or Mozilla FireFox, to display set page 60 in response to an inputted request. As illustrated, web page 60 contains header information 62 identifying the source of the web page. This information may include the company name, trademark, or logo of the company responsible for distributing a package to the user. In this example, the illustrated web page is generated and displayed user in response to the entering of reference code 68 by the user. It shall be appreciated that a similar web page displaying other wines may be generated in response to other reference codes or package IDs.

Below the heading information 62, web page 60 contains package information 64 relevant to the package in which the associated wine was included. In the event that a particular wine has been included in multiple packages, more or less information may be displayed as desired. In this embodiment, the package information 64 includes the type of wines contained, their corresponding price range, and the unique ID of the package. Below this information 64, a wine information section 66 is displayed. Wine information section 66 contains a listing, such as listing 68, which corresponds to the wine associated with the reference code entered by the user. As illustrated in FIG. 3, this information may include the wine's name and price, as well as the name, address, and contact information of the winery that made the wine. Additionally, the web page 60 may contain hyperlinks to a page of popular review of the wine, a direct link to the winery's website or a link to a map indicating retailers in the user's area who distribute the wine.

In addition to the above content, in this embodiment, web page 60 also contains a purchase button 70 which allows the user to immediately place an order for a larger quantity of the wine associated with the reference code they entered. It shall be appreciated that purchase button 70 may lead to a web page containing online ordering functionality for accepting an order for wine. Additionally, the information may be included on the current web page 60 in place of the purchase button 70.

It shall be appreciated that button 70 provides a completion to a satisfying experience for the user, in that the user can conveniently sample a variety of wines, visit a web page to satisfy the user's curiosity of the wines being tasted to quickly learn of the wines' identities, and then have the opportunity to immediately place an order for delivery of wine(s) of particular interest.

Further, in order to allow the user to quickly look up other wines, a reference entry box 74 in which a user may enter another reference code, such as reference code 72, may be provided. The user may then click on box 76, and be taken to a similar web page for the wine associated with reference code 72.

Returning to FIG. 2b with continued reference to FIG. 3, it shall be appreciated that reference code 34 of carton 20 corresponds to reference code 48 of wine listing 46 of reference source 14. This correlation allows the consumer to identify the wine contained within a carton after tasting. In one preferred embodiment, reference code 34 is a unique alphanumeric sequence. In a further embodiment, reference code 34 is a result of the combination of the package ID indicated in section 42 and individualized coding for each container in the package. It shall be appreciated that reference code 34 may be any number, letter, or sequence thereof as well as any color, shape, design, or distinguishing mark that does not immediately identify the specific wine contained therein, but does so indicate when used in connection with a reference source.

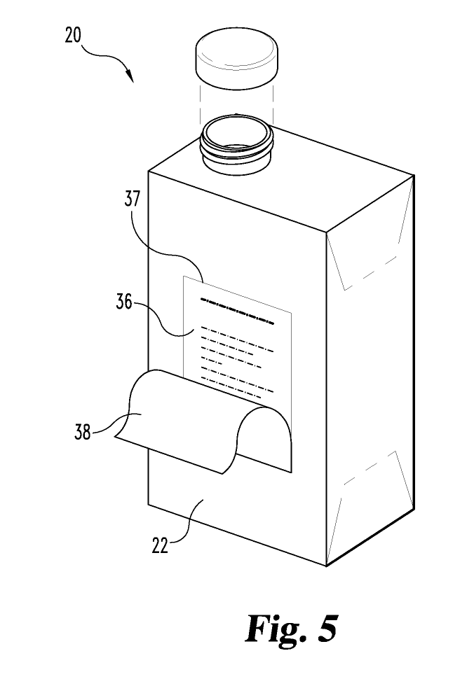

Turning to FIG. 5, another embodiment suitable for use in identifying the wine contained in a container 12, such as carton 20 is illustrated. Front face 22 of carton 20 may have a removable strip, such as strip 38, which may be pulled away to reveal label 37 having information 36 identifying the wine contained in carton 20 thereon. It shall be appreciated that label 37 may be eliminated in an embodiment where information 36 is directly applied to container 20. Information 36 may include the name of the wine contained or any other information such as that disclosed herein on pamphlet 40. In another form, information 36 may be printed on the back of strip 38. Strip 38 is attached to carton 20 and may be removable in a variety of ways including perforated tear lines, low-strength adhesive, and any other method known to one of skill in the art.

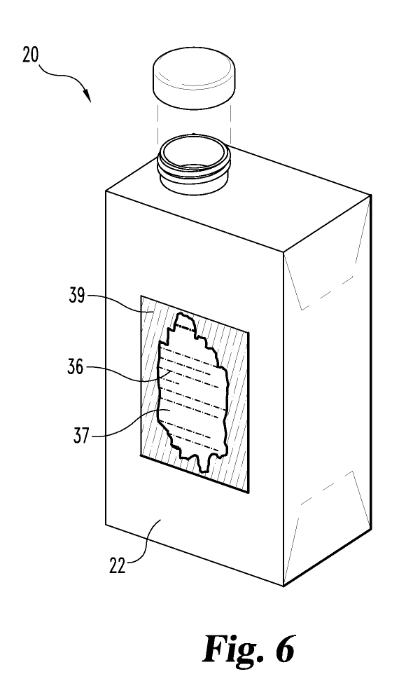

Turning to FIG. 6, yet another embodiment suitable for use in identifying the wine contained in a container 12, such as carton 20 is illustrated. Front face 22 of carton 20 may have removable surface, such as surface 39, which may be removed in a variety of methods to reveal label 37 having information 36 identifying the wine contained in carton 20 thereon. Information 36 may any include information such as that disclosed herein on pamphlet 40, or may optionally include a reference code. Surface 39 may be an opaque printing ink applied to label 37 to hide information 36 already printed on the label 37 so that surface 39 can be scratched off to reveal the printed information 36. Various other methods known to one of skill in the art may be used to conceal information 36 from the consumer until after the tasting of the wine within carton 20. Other embodiments may include an ink layer printed over information 36 on carton 20 so that a colored filter or semi-translucent overlay sheet is required to accurately read information 36.

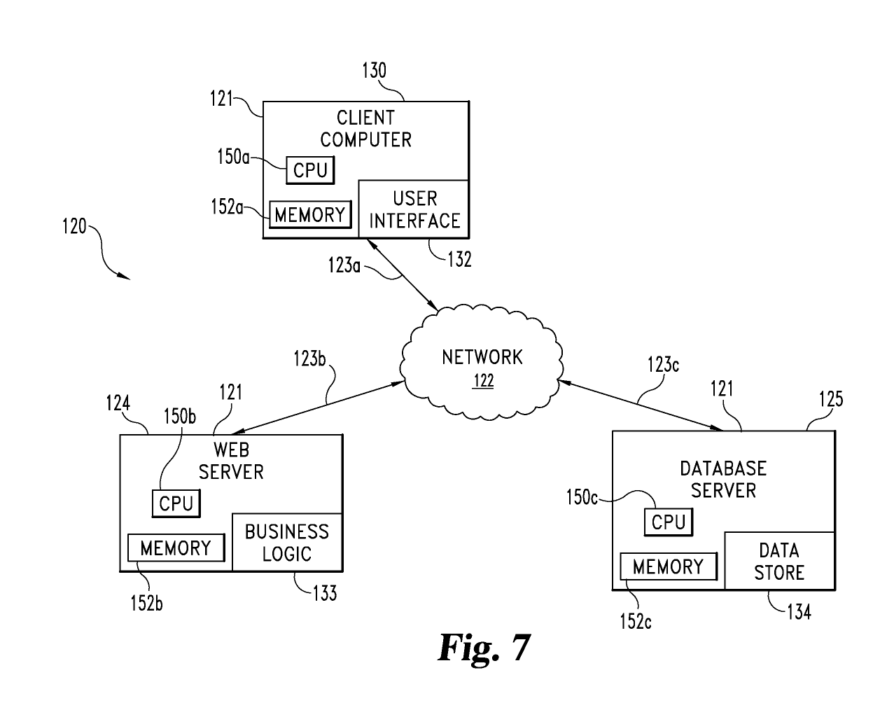

Turning to FIG. 7, a diagrammatic view of computer system 120 suitable for use in one embodiment of the present invention is shown. Computer system 120 includes computer network 122. Computer network 122 couples together a number of computers 121 over network pathways 123a-123c. More specifically, system 120 includes several servers, namely Web Server 124 and Database Server 125. System 120 also includes a client computer. While computers 121 are each illustrated as being a server or client, it should be understood that any of computers 121 may be arranged to include both a client and server. Furthermore, it should be understood that while three computers 121 are illustrated, more or fewer may be utilized in alternative embodiments.

Computers 121 include one or more processors or CPUs (150a, 150b, 150c respectively) and one or more types of memory (152a, 152b, 152c respectively). Each memory 152a, 152b, 152c preferably includes a removable memory device. Each processor 150a-150c may be comprised of one or more components configured as a single unit. Alternatively, when of a multi-component form, a processor 150a-150c may have one or more components located remotely relative to the others. One or more components of each processor 150a-150c may be of the electronic variety defining digital circuitry, analog circuitry, or both. In one embodiment, each processor 150a-150c is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory 152a-152c (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, in one embodiment each computer 121 is coupled to a display and/or includes an integrated display. Computers 121 may be of the same type, or a heterogeneous combination of different computing devices. Likewise, displays may be of the same type, or a heterogeneous combination of different visual devices. Although not shown, each computer 121 may also include one or more operator input devices such as a keyboard or mouse to name just a few representative examples. Also, besides a display, one or more other output devices may be included such as a loudspeaker or printer. Various display and input device arrangements are possible.

Computer network 122 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 120 can be embodied in signals transmitted over network 122, in programming instructions, dedicated hardware, or a combination of these. It should be understood that more or fewer computers 121 can be coupled together by computer network 122.

In one embodiment, system 120 operates at one or more physical locations where Web Server 124 is configured as a web server that hosts application business logic 133 for a wine distribution system, Database Server 125 is configured as a database server for storing information about individual users, wine packages, and individual wines; and client computer 130 is configured for providing a user interface 132, for placing orders for wine packages, retrieving information concerning the wines, and ordering additional wines. It shall be appreciated that client computer 130 may be any web-enabled device, such as a PDA, Blackberry, or Mobile Phone, to name just a few illustrative examples. Furthermore, user interface 132 of client computer 130 may be an installable application such as one that communicates with web server 124, browser-based, and/or embedded software, to name a few non-limiting examples. In one embodiment, software installed locally on client computers 130 is used to communicate with web server 124. In another embodiment, web server 124 provides HTML pages, data from web services, and/or other Internet standard or company proprietary data formats to one or more client computers 130 when requested. One of ordinary skill in the art will recognize that the term web server 124 is used generically for purposes of illustration and is not meant to imply that network 122 is required to be the Internet.

Typical applications of system 120 would include two servers 124 and 125, but it will be appreciated by those of ordinary skill in the art that the one or more features provided by Web Server 124 and Database Server 125 could be provided by the same computer or varying other arrangements of computers at one or more physical locations and still be within the spirit of the invention.

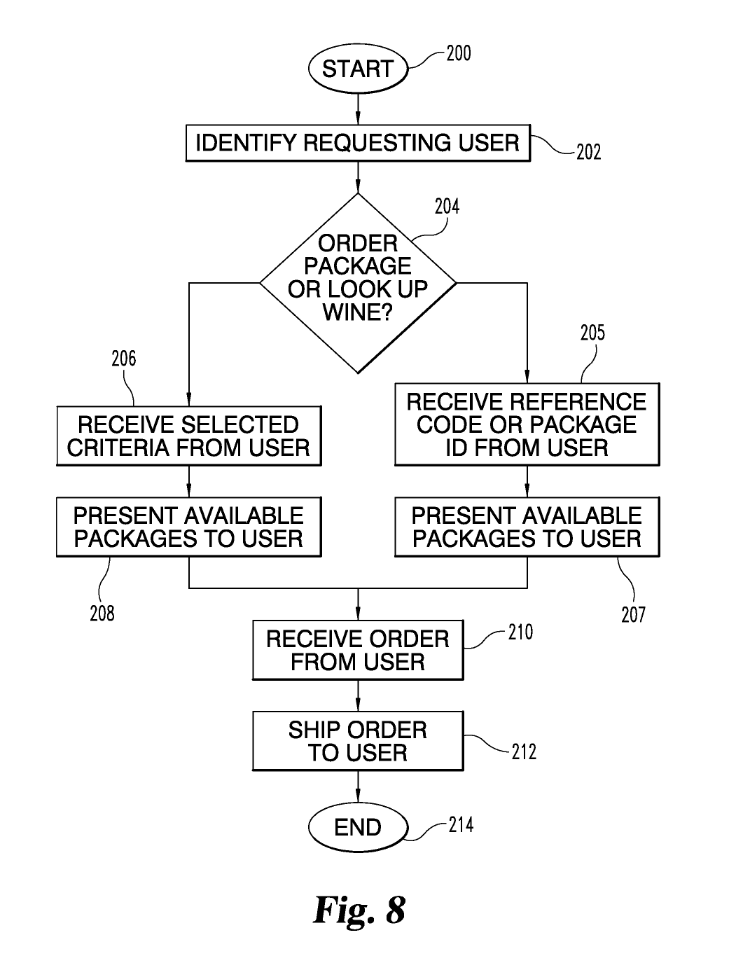

Turning to FIG. 8, an associated method for distributing wine in one aspect of the present methods is described in flowchart form. In one form, the process of FIG. 8 is at least partially implemented in the operating logic of system 20, however, it shall be appreciated that the steps may be performed using a telephone or other communication medium. The method begins at start point 200, with web server 124 receiving a hit through network 122 and identifying the requesting user (stage 202). For example, the user may be required to log-in with a username and password combination, or the server 124 may identify the user using a cookie or similar object stored on the user's system, such as 130a. If the user is a new user, they may be allowed to continue along as a guest, or may be prompted to create a new user profile. If the user is identified, server 124 is able to retrieve any information, if available, concerning prior purchases of wine packages made by the user as well as subsequent orders for larger quantities of specific wines stored in database server 125.

Once this step is complete, the server 24 then allows the user to selectively proceed to browse wine packages available for purchase or identify the wines contained in a previously purchased wine package (stage 204). If the user chooses to view available wine packages, the server 124 presents the user with a plurality of options concerning the type of wine they are interested in. For example, the system may allow the user to select a price range for the wines, a particular region of growth, or a particular wine type, to name just a few representative examples. Once the user has completed their selection, the options are communicated to the server 124 (stage 206). Additionally, the server 124 may create a record associated with the user in database server 125 indicating the wine package purchase.

By utilizing the received criteria, the server 124 is able to query database server 125 and identify the available wine packages which suit, or closely resemble, the user's criteria. Additionally, the server 124 may be programmed to signal the user as to any package containing a wine which the user has already received in a previously purchased package. Further, the server 124 may rank the available packages prior to presenting them to the user based upon the user's prior ordering tendencies. The server 124 then presents a page to the user showing each package and its relevant details (stage 208). The user may individually select each package and learn more about its content, including reviews of others users who have tried the package, or statistics concerning its popularity.

Once the user has selected a package and is ready to place an order, the server 124 transitions to a payment and verification process in which an acceptable form of payment is taken, such as Visa®, Mastercard®, American Express®, Discover® Card, or Paypal®, and the user's information, including a shipping address, and age information is taken and verified, if not previously stored. Once this information is completed, the user gives a final approval and the server 124 receives the order (stage 210). Once the order has been received, the server 124 sends a request to have the order fulfilled by shipping the appropriate package(s) (stage 212) to the user, and the process ends at end point 214.

Once the user has received the package, and has had the opportunity to sample the wine, he/she may then revisit the site hosted by server 124 and log in according to the procedures described herein. However, this time, the user might choose to identify the wines contained in a previously purchased wine package in stage 204. The server 24 may then display a page which may be populated with the packages the user has recently purchased or which allows the user to enter either a unique package ID or a unique reference code associated with a container in the package (stage 205).

Upon receiving an ID or reference code, the server 124 may display a reference page identifying the wine associated with the reference code, such as FIG. 5 (stage 207). It shall be understood that in response to a package ID, the server 124 may display information regarding all of the wines contained, and in response to a single reference code the server 124 may only display information associated with the single wine which corresponds to that reference code. In addition, the server 124 is able to take an order from the user for a larger quantity of one of the wines displayed. The order may be processed by server 124 for handling or may be sent along to a larger distributor or the individual winery for fulfillment. In another form, the system may also be able to provide the user with information on a location as to where they may purchase the wine locally. If the user opts to place an order for one of the identified wines, the server 124 returns to stage 210 and completes the order verification and submission process. In addition, server 124 may collect statistics from the plurality of users, such as the percentage of users who purchase each wine after receiving it, in order to extract valuable marketing information.

Further embodiments of the present system and method may include the extension of the principles of the present disclosure to the distribution and sampling of other beverages including, but not limited to, beer, distilled spirits, and specialty alcoholic drinks such as hard lemonade, wine coolers, and cider.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. Hence, the proper scope of the present invention should be determined only by the broadest interpretation of the appended claims so as to encompass all such modifications as well as all relationships equivalent to those illustrated in the drawings and described in the specification.

1.-8. (canceled)

9. A package comprising:
a plurality of sealed containers containing a plurality of differing wines, each of said containers having a label including an associated reference code, said label being otherwise free of visible marks indicating the particular identity of the wine contained therein, said label being affixed to said container prior to the commercial distribution of the package to the consumer; and
wherein a consumer is able to blindly sample the wines in said containers and thereafter identify the particular wines in said containers by correlating said reference codes to a reference source.

10. The package of claim 9, wherein said plurality of sealed containers includes at least 3 containers.

11. The package of claim 9, wherein said plurality of sealed containers includes at least 4 containers.

12. The package of claim 9, wherein said plurality of sealed containers includes at least 6 containers.

13. The package of claim 9, wherein said plurality of sealed containers are single-serving containers.

14. The package of claim 13, wherein said single-serving containers contain 187 ml of wine.

15. The package of claim 13, wherein said single-serving containers contain 250 ml of wine.

16. The package of claim 13, wherein said sealed containers are cartons.

17. The package of claim 13, wherein said sealed containers are bottles.

18. The package of claim 9, wherein each of said plurality of sealed containers contains a wine from the same wine variety.

19. The package of claim 9, wherein said plurality of sealed containers includes a first container and a second container;
wherein said first container and said second container contain wines having a different variety.

20. The package of claim 9, wherein each of said plurality of sealed containers contains a wine from the same growth region.

21. The package of claim 9, wherein each of said plurality of sealed containers contains a wine having a price within the same price range.

22. The package of claim 21 wherein said price range is from $15 to $25 per bottle.

23. The package of claim 21 wherein said price range is from $25 to $50 per bottle.

24. The package of claim 21, wherein price range is above $50 per bottle.

25. The package of claim 9, wherein said reference code is a string of alphanumeric characters.

26. The package of claim 9 further in which said reference source lists the reference code for each container in said package and provides the particular identity of the wine corresponding to said reference code.

27. The package of claim 26 wherein said reference source includes information to allow a consumer to place an order for said wine.

28. The package of claim 27 wherein said reference source is a pamphlet.

29. The package of claim 27 wherein said reference source is a web page.

30. The package of claim 9 wherein said containers indicate the varietal of the wine contained therein.

31. A package comprising:
a plurality of sealed containers containing a plurality of differing wines, each of said containers having a label indicating the identity of the wine contained, at least one of said containers also having a surface covering said label concealing the identity of the wine contained therein, wherein said surface is affixed to said label prior to the commercial distribution of the package to the consumer;
wherein a consumer is able to blindly sample the wine in said at least one container and thereafter identify the particular wine contained therein by removing said surface from the container and thereby exposing said identifying label.

32. The package of claim 31, wherein a consumer is able to identify the wine contained in a container by removing said surface to reveal said label.

33. The package of claim 32, wherein said surface is a printed ink.

34. The package of claim 32 wherein said surface is a removable strip.

35. The package of claim 31 wherein said label is directly printed on said container.

36. The package of claim 31, wherein said plurality of sealed containers includes at least 3 containers.

37. The package of claim 31, wherein said plurality of sealed containers includes at least 4 containers.

38. The package of claim 31, wherein said plurality of sealed containers includes at least 6 containers.

39. The package of claim 31, wherein said plurality of sealed containers are single-serving containers.

40. The package of claim 31, wherein each of said plurality of containers contains a wine from the same wine variety.

41. The package of claim 31, wherein said plurality of sealed containers includes a first container and a second container;
wherein said first container and said second container contain wines having a different variety.

42. The package of claim 31, wherein each of said plurality of sealed containers contains a wine from the same growth region.

43. The package of claim 31, wherein each of said plurality of sealed containers contains a wine having a price in the same price range.

44. The package of claim 31 further comprising an overlay sheet.

45. The package of claim 44, wherein said surface comprises a printed ink which allows a consumer to clearly view said label using said overlay sheet.

46. The package of claim 45, wherein said overlay sheet in a colored translucent material.

47. The package of claim 46, wherein said surface and said overlay sheet are the same color.

48. The package of claim 31, wherein said containers indicate the type of wine contained.

49-66. (canceled)
